(19) United States
(12) Patent Application Publication
(10) Pub. No.: US 2007/0280445 A1
(43) Pub. Date: Dec. 6, 2007

(54) Method for Interacting Via an Internet Accessible Address-Book Using a Visual Interface Phone Device

(76) Inventor: Roy Shkedi, Forest Hills, NY (US)

Correspondence Address: JOHN ALEXANDER GALBREATH, 2516 CHESTNUT WOODS CT, REISTERSTOWN, MD, 21136, US

(21) Appl. No.: 11/677,770

(22) Filed: Feb. 22, 2007

Related U.S. Application Data
(60) Provisional application No. 60/803,889, filed on Jun. 5, 2006.

(51) Int. Cl. H04M 11/00

(52) U.S. Cl. 379/93.23

(57) ABSTRACT

From a visual-interface-enabled voice-network-operative telephone device, a user navigates an Internet based address-book, and upon finding a desired record in the address-book, the user will cause a server associated with the address-book to initiate a call or a message to a device associated with the electronic address stored in the record (e.g. telephone number, VOIP address, email address, etc.). This is done by the server (A) receiving access to an internet accessible address-book; (B) accepting a dial-up connection from a user, wherein the dial-up is from a visual-interface-enabled voice-network-operative telephone device; (C) receiving navigation commands from the device; (D) sending at least one portion of a record in the address-book to the device; and optionally thereafter accepting a communications command from the device relating to an electronic address sent by the server to the device to establish a voice connection with the address or to send a message to the address.

### CROSS-REFERENCES TO RELATED APPLICATIONS

This application claims priority from, and the benefit of, applicant's provisional U.S. Patent Application No. 60/803,889, filed Jun. 5, 2006 and titled “METHOD FOR LOCATING AND CALLING A PHONE NUMBER IN AN INTERNET ACCESSIBLE ADDRESS-BOOK USING A VISUAL INTERFACE PHONE DEVICE”. The disclosures of said application and its entire file wrapper (including all prior art references cited therein) are hereby specifically incorporated herein by reference in their entirety as if set forth fully herein.

Furthermore, a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to using a visual-interface-enabled voice-network-operative telephone device to enable a server-side address-book transaction. More specifically, the present invention relates to transactions, such as finding and calling a phone number, in an internet accessible address-book using a visual interface enabled voice network operative phone device.

### BACKGROUND OF THE INVENTION

While telephones are being used for a very long time, till today most people do not enter their personal address-books into their phones, whether landline phones (such as POTS based or VOIP based), cellular phones or phones in general for several reasons:

1) It is difficult to enter letters using the phones' keypad when there are several letters represented by one digit/button/key. In other words if you want to enter the letter ‘C’ you have to press the ‘2’ key three times. Alternatively, different predictive text programs were developed in an attempt to help users enter letters by letting them type a name and then letting them choose the word they meant from all the combinations of words created by the keys they typed. Still, this method has proved also cumbersome and most people don't use it.
2) It requires them to learn how to program their phones. Since most people replace their phones every 2-3 years to get a better model (new/more features, better reception, different cellular carrier etc) they find it difficult to learn how to program a new phone for the purpose of reentering their address-book all over again in 2-3 years.
3) Most phones, whether landline phones or cell phones have limited number of address-book records that they can keep in memory, which require the user to figure out which numbers are most often used by him and only those address-book records to enter. As naturally over the course of time users make new friends and business acquaintances they need to add them to their phone's address-book which at that point requires them to figure out which names they use less and taking them out of their phone's address-book to make room for the new phone numbers they would like to add.

Personal computers have enabled users for years to manage very large address-books conveniently but since most of the computers are not connected to a cell phone or a landline phone, the user still has to look-up the person he would like to call on the computer's address-book software and then dial it into his phone.

While some phones, whether landline models or cell phones, come with a cable and a software that enable the user to connect the phone to his personal computer via the cable, to install the software that came with the phone on his personal computer and download his address-book to the phone, it is still inconvenient since it requires the user to sync his phone with his computer occasionally to get recently added addresses downloaded to the phone.

Also, as noted before many of the phones do not have the capacity to store all of the user's address-book and the user has to choose which records he would like to have accessible over the phone. Price is also an important factor, as many of the phones with a capacity to store large address-books are more expensive. Usually an additional price is charged for the cable and the synchronizing software as well.

The same is true for web-based address-books such as the Yahoo or MSN address-books. The user has to look up the person he would like to call on the web-based address-book and then dial the found number into his phones.

Computers that are connected to phone lines whether POTS lines, VOIP lines over the web or cellular lines enable the user to find the person he would like to call on the computer's address-book (whether the address-book is stored locally on the computer or centrally on the web) and dial to that person by asking an application to connect him to that person.

Under the above definitions fall the following:

### 1) An address-book software such as Outlook on a personal computer with a headset, microphone and a modem connected to a landline where the user can dial directly from the software and speak to the other party via the headset and the microphone.

2) An address-book software such as Outlook on a personal computer with a headset, microphone and an internet connection where the user can ask a software application (either outlook or a different application that can pick-up the chosen number from the address-book software) to connect him with the chosen phone number via VOIP over the web.
3) A web based address-book software such as Yahoo address-book, MSN address-book, Skype address-book and others that enable a user accessing them from a personal computer with a headset, microphone and an internet connection to ask to be connected to a phone number of a person he found within the web based address-book and a web based application tied to the web based address-book (such as an instant messenger) will connect the user with the chosen phone number via VOIP over the web.

Another existing application enables a user to find a number of a person he would like to reach in an address-book software like Outlook on a personal computer and then the application contacts a VOIP phone service provider such as Vonage over the web, where at that point the VOIP phone service provider will call the user's landline first (the landline provided to the user by the service provider) and once the user answer his landline, the phone service provider will dial the number chosen by the user in the personal computer's address-book.

As an address-book is an important application to many people that would like access to their personal address-book wherever they are, portable phone devices, which are also computers, were developed. Examples of such portable phone-computer devices are the Treo smart-phone from Palm or the Blackberry from RIM. Those portable phone-computer devices enable a user to sync (short for synchronize) his phone's address-book with a personal computer address-book where the user can easily enter new addresses either to the phone's address-book via the phone's keyboard (in many cases a full QWERTY keyboard) or enter a new address via his personal computer keyboard and sync the address-books of the phone and the personal computer so both would include the same address records.

Moreover, as some portable phone-computer devices also have internet access, those phones could be used to access web based address-books such as the Yahoo address-book and an application on the phone would recognize that a number has been chosen by the user, the phone will disconnect from its internet connection and dial the chosen number over the phone's voice line.

For example, a Treo phone device with an internet access receiving a cellular service from Cingular (a US cellular carrier) could enable a user to access his Yahoo address-book via the phone's internet connection and then provide the user with the option to dial a phone number found by the user within the Yahoo address-book. The phone will disconnect its internet connection and then dial to the chosen phone number using a voice channel.

It should be noted that the described portable phone-computer device with an internet connection could act in the same way as a non-portable computer with an internet access, headset and a microphone and enable a user to access a web based address-book software such as Yahoo address-book, MSN address-book, Skype address-book and others that enable a user accessing them, finding a person they would like to be connected with in their address-book and be connected to them by a web based application tied to the web based address-book (such as an instant messenger) that will connect the user with the chosen phone number via VOIP over his portable phone-computer's internet connection.

While such portable phone-computer devices are very useful they are also very expensive. Cost of hundreds of dollars leads most users not to buy them. Also, many people find phones that have full keyboards to be too big and prefer smaller phones that have a keypad only as a keypad is enough if you use the phone to make and receive phone calls only.

Another address-book application, offered by cellular carriers mainly for the purpose of allowing people to safely access their address-book while driving without having to take their eyes off the road and look on the phone screen, is an address-book application that enables its user to navigate and call people in their address-book using voice commands.

The user uploads their address-book via a web interface, either by manually entering their address-book or by exporting their address-book from a personal computer address-book software application such as Microsoft outlook. The user can also add a limited number of address-book records to his address-book via voice commands from his wireless cellular device (Cingular, a US cellular carrier, limits that number to 20 numbers for example).

In order to access the address-book, the user dials *8 for example, then order the system with a voice command to call the home number of Mr. John Ivanovitch.

This kind of system, while used by some people while driving, was not adopted by consumers on a large scale; for several reasons. The main reason this application is not adopted on a large scale is due to its high error rate in recognizing what name was pronounced by the user. The system difficulty in recognizing names vocalized by a user is due among other things to differences between the way a name is written (in the address-book) and pronounced by the user, difficulties of the system to understand different accents and dialects as well as system sensitivity to background noises such as street noise, wind noise when driving with the windows open, radio in the background etc.

Yet another address-book application worth mentioning was the one supported by ADSI protocol. ADSI (Analog Display Services Interface) is the standard protocol for enabling alternate voice and data services, such as a visual display at the phone, over the analog telephone network. Developed by Bellcore in 1993, ADSI was built into devices such as special telephones with small display screens, cable TV set-top box, personal digital assistants (personal digital assistant), pagers, and personal computers with telephone applications.

A popular application enabled by ADSI is Call Waiting Deluxe, an application that displays the name and number of an incoming call while you are on the phone. If you have an ADSI screen phone, several options are displayed on your screen including switching to the new call, forwarding the new call to your voice mail, putting the new caller on hold, playing a recorded message, or dropping the current call and switching to the new call.

Other ADSI applications include:
Visual voice mail, the display of telephone voice mail menu options and a list of your voice mail messages
Visual directory, a service that allows you to locate the telephone number of an individual or business and, possibly at extra charge, to download the address of that individual to your screen phone
E-mail browsing, allowing you to send and receive e-mail messages via an ADSI-enabled device.
Schedule-based services, faxing abilities, notification of incoming e-mail messages, home banking, ticket purchasing, and access to train and plane schedules

ADSI phones feature softkeys, which work much like the keys on an automatic teller machine. Softkeys allow users to select different options or activate different features, depending on which menu is displayed on the screen.

Unlike voice-prompt menus, which can be time-consuming and require a lot of concentration, visual menu-based prompts and softkeys work together to enable users to view all possible choices at one glance and make selections at their own pace.

When ADSI was introduced, BellSouth offered the Northern Telecom PowerTouch 350, which featured an eight-line by 20-character lighted display with six context-sensitive softkeys. An upgradeable module slide in and out of the base unit and offered an easy way to get new features as they become available without requiring the purchase of a completely new unit. Planned enhancements at the time included modules with smart card readers and a mini-keyboard for entering more extensive responses to visual prompts.

The Rollout BellSouth and Nortel played key roles in the development and introduction of the ADSI protocol. Working closely with Bellcore, they developed the protocol, took it through extensive testing and trials, and introduced it to BellSouth subscribers early in 1995.

An Address-book application supported by ADSI was expected to expand the usefulness of the dial pad. For example, subscribers can use the dial pad to create and edit their personal on-line calling directories. Subscribers are able to list more entries in their calling directories than they could with pre-ADSI display phones because names and phone numbers are stored on a central server for each subscriber rather than on the phone set. Using these large, customized directories, subscribers can enjoy far more powerful versions of speed dialing, distinctive ringing, selective call forwarding or call waiting, and other directory-based services.

It should be noted that ADSI phones did not catch-up with the mass market. One of the reasons was price. The above-mentioned PowerTouch 350 from Northern Telecom was offered for $348 dollars in 1995, which was and still is expensive for a residential phone.

Also, worth mentioning is U.S. Pat. No. 5,930,341—ADSI web browser for retrieving internet data files which relates to A browser device and method for interfacing screen-display telephone terminals with the Internet. The browser device located on an ADSI capable telephone platform server, retrieves requested data files from an Internet site and formats the retrieved data file specifically for display on the screen-display telephone terminal.

As noted at the beginning of the prior art overview, despite all of the many options of different address-book applications available to consumers, till today most people do not enter their personal address-books to their phones, whether landline phones (such as POTS based or VOIP based), cellular phones or phones in general.

Alternately stated, there are two central features of today's everyday telephone-user information experience. Firstly, the user typically has at least one electronic address-book; which may reside on a cellular telephone, a personal computer, or on a server of a computer network. Typically such a server is part of a web-based service provided by Yahoo, Microsoft, AOL, or the likes. These electronic address-book interactions are generally visual. There is a great disparity between the facile computer terminal data entry and data extracting capacity and the often-cumbersome telephone keypad emulation of such functions. Nevertheless, all of these address-book systems are typical for ordinary users. Secondly, a common user experience typically includes independently calling into an organization, such as an office or a bank, and finding himself listening to audio menus and navigating by using his phone's keypad; just to find and be connected to an extension in a PBX, or to leave a message, etc. For large address-books—as represented by these audio navigation menus, the navigation by audio playback and user keypad feedback is drudgingly tedious. Accordingly, there is a longstanding general need to somehow combine the facile visual navigation of address-books with the telephone call-into address-book experience—as typified by the calls to banks or other organizations. More specifically, there is a need to provide the benefits of visual navigation of even ones personal address-book—when one is calling in from a remote location; wherein this may only be actualized if one is calling form some visual-interface-enabled telephone device. This need is most acutely felt when the telephone device is interconnected to the remote address-book via a voice-network-operative link—since that remain a typical circumstance where the bandwidth of information transfer is most restricted. Of course, the need is most critical for an instance where a user would wish to remotely connect to his very own address-book.

There are many address-book systems described in the prior art.

U.S. Pat. No. 6,961,414 discloses a telephone network-based method and system for automatic insertion of enhanced personal address-book contact data; telephone network-based system includes an application unit to coordinate the addition of new contact data by a user via his telephone, and/or is used in conjunction with his Web-browser or other Internet/Intranet access device.

U.S. Pat. No. 6,956,942 discloses a multi-modal address-book; a centralized address-book that stores multi-modal contact information and that is accessible using different devices and different communications modes and formats.

US20050157858 discloses methods and systems for contact management wherein contacts may be added to the address-book from one or more sources.

US20020006124 discloses methods and apparatus for an audio web retrieval telephone system wherein “ . . . an alias can be used that represents an address that has already been input via the Web interface into the subscriber's personal addressbook”.

U.S. Pat. No. 6,687,362 discloses an automatic address-book update system; automates the data collection and maintenance tasks for computerized address-book systems; Local Exchange Carrier (LEC) maintains a customer database (identifying the name, address, telephone number) of their local customers; LEC identifies the address-book update service authorization for the subscriber, retrieves the calling/called party's customer database information, and transmits this information to the subscriber's addressbooks system to populate an entry therein under the name of the calling/called party.

Other references also describe variants of the basic approaches listed above. These variants include: US20050243993 US20040258234 US20040166832 US20040052356 US20030179864 US20020052195 US20010048676 U.S. Pat. No. 6,996,227 U.S. Pat. No. 6,853,713 U.S. Pat. No. 6,792,082 U.S. Pat. No. 6,707,811 U.S. Pat. No. 6,650,735 U.S. Pat. No. 5,897,635 U.S. Pat. No. 5,483,586.

Now in combination these references demonstrate that the requisite components for combining the best of electronic address-books with telephone menu navigations systems exist—however they have not been combined to address the longstanding problems described above. Thus, the users of ordinary visual-interface-enabled voice-network-operative telephone devices remain with the longstanding problem of tedious audio menu navigations or inconvenient central address-book access from an ordinary telephone device. Again, the need is most problematic for a user who wants to make best visual navigation usage of his own remote address-book.

### BRIEF SUMMARY OF THE INVENTION

The aforesaid longstanding needs are significantly addressed by embodiments of the present invention, which specifically relates to a method for locating and calling a phone number in an internet accessible address-book using a visual interface phone device. The instant method is especially useful in man-computer interactions wherein there exists visual-interface-enabled telephone device on one side, a server capable of accepting a dialup connection on the other side, and a voice-network-operative data-communications infrastructure there between.

The present invention relates to basic embodiments (and variations thereto and implementations thereof) of a method for interacting via an internet accessible address-book (e.g. locating and calling a phone number in the address-book, arranging for the sending of voicemail to email or voicemail, redirecting incoming telecommunications, and the likes) using a visual interface phone device, wherein the address-book is navigated via a visual-interface-enabled voice-network-operative telephone device. These basic embodiments of the method according to the present invention are including the steps: (A) a server, via Internet, receiving access to a user's address-book, wherein the address-book has more than one record; (B) the server accepting a dial-up connection from the user, wherein the dial-up is from a visual-interface-enabled voice-network-operative telephone device; (C) the server receiving navigation commands from the device, and the commands are for navigating within the address-book; and (D) the server sending at least one portion of a record in the address-book to the device, and the server arranging for the at least one portion to be sent in a format readable by the visual-interface-enabled voice-network-operative telephone device. According to the first variation that we will describe in detail, the instant method in general further includes additional steps (E) the server accepting a communications command from the device (e.g. the communications command is to establish a voice connection to an electronic address associated with a record of the address-book); and (F) the server executing the communications command (e.g. establishing the voice connection connecting the device to the electronic address). However, other variations will be described that extend the instant method in other ways, which relate to incoming and/or outgoing transactions via the same server accessible address-book.

It should be noted that the above server is referred to as the Central Address Book (“CAB”) Server or the Address Book Server and the above-described service is referred to as the Central Address Book (“CAB”) Service in many instances below. Often, in the context of a non-limiting example, the CAB will be called a “user's Address-book” or a “Subscriber Address-book”.

More specifically, the instant method for locating and calling a phone number in (interacting via) an internet accessible address-book using a visual interface phone device relates to embodiments wherein navigation of address-book content by a remote user occurs via a visual-interface-enabled voice-network-operative telephone device. Simply stated, via a device that at least has some alphanumeric presentation display—preferably one capable of showing at least a name field from the address-book. For practical purposes, this capability is substantially equivalent to that needed to show a caller ID—which in turn is typically a text string that a user assigns to a predetermined incoming calling number or that a caller assigned to himself as a more descriptive identity than the system address “telephone number” Nevertheless, a multi-line alphanumeric display would be preferred—in that it allows a convenient scrolling function to be enabled. According to more advanced embodiments, a graphics display would be even better, since a user might select a destination in his address-book by selecting a thumbnail sketch or small digital photograph or icon associated with a telephone number (or the likes) in his address-book.

These various basic embodiments of the method according to the present invention are including the steps mentioned above. More specifically, in step (A) a server, via Internet, receiving access to a user's address-book (or to a public address-book or to a private address-book which the user has access permission), wherein the address-book has more than one record—relates to a fundamental facilitation of a server having a capability to present information from a user's address-book. This includes the case where the address-book is resident on the server, where the server has received a copy of the address-book, and the case where the server simply acts a substantially transparent communications conduit to another location where the address-book is resident or where a copy of the address-book is resident, etc. The notion of a record here relates to a entry in an address-book that may include any of the following: personal name, family name, telephone number, mobile phone number, facsimile number, pager number, instant messenger user name, address, email address, nick-name, thumbnail sketch, small photo, icon, affiliation, title, memo, profession, reference, special audio-clip, or the likes. Thus the record may be a line item in a tabular list of alphanumeric data or it may be a logical folder having alphanumeric and other data items. There are lots of ways that the server may come to have or access the content of the address-book, and these may include—for example—by email, FTP, connection via a telecommunications or data-communications infrastructure, via a mirror site, or the likes.

More specifically, in step (B) the server accepting a dial-up connection from the user, wherein the dial-up is from a visual-interface-enabled voice-network-operative telephone device—relates to a front end facility of the server as it is interconnected to a telecommunications infrastructure. On the one hand there is a bandwidth restrictive aspect to a dial-up connection that propagates in part or in whole over a voice operative network. On the other hand there is an upgraded hardware facility above the plain old telephone system user equipment—since the user device is enable with some graphics interface, as described above.

Now, a part of the dial-up connection (e.g. at a first connection event, at this connection event per se, or thereafter) may include the server receiving some indication of the nature of format that the visual interface is capable of accepting as well as the phone's hardware and software capabilities. In another implementation, the server will know which format the phone's visual interface is receiving based on the kind of line used to connect to the server whether it is a POTS line, a VOIP line or a cellular line. In further yet another implementation the server will know which format the phone's visual interface supports according to the phone company's equipment used to provide the phone service to the user. The server will recognize the phone company's equipment according to the phone number from which the user originated the call to the server as the server will have a database of phone numbers and the different phone companies that provide phone service to those phone numbers and the different equipment they use to serve those numbers (whether POTS, VOIP etc). In another implementation a user will register the kind of interface his phone supports as well as the phone's model with the central address book server. In another implementation the central address book service will be offered by the phone company that will offer it just to its subscribers and the phone company may support only one kind of phone's visual interface. Depending on the user's phone hardware, there could be phones that have a background memory or a cache or a large buffer that—for example—allows storage of more lines of text than the display is capable of presenting at a given instance. Information of the phone's hardware and software capabilities may lead the server to send the phone more address book records than requested by the user to be kept in the phone's cache so in case the user ask for a record already in the phone's cache, the record will be pulled from the cache and a faster navigation experience of the central address book will be the result. There may also be circumstances where a bandwidth limitation of the voice operative telephone network causes the server to elect a peculiar protocol that is more efficient than the ordinary over voice operative network protocols for the transmittal of alphanumeric data or graphics—according to the specifics of the server with device data interactions. However, it should be understood by the ordinary man of the art that the server executing the method steps of the instant invention often will in fact be the server associated with the method steps interconnected via intermediary server(s) to the device—so the actual compatibility between the address-book content and the device must be made compatible with the device format before reaching the device—but not necessarily by the server accessing the address-book. For the purposes of other embodiments of the instant invention, an address-book that permits a non-owner user query access to an address-book is substantially equivalent to that address-book being owned by the user for the purpose of query. That is to suggest that there are numerous possible relationships between the device that accesses the address-book and the owner of that address-book. It may be that they are the same entity. It may be that the owner of the address-book grants query privileges to a select few or to the general public. It may be that the owner allows some select few to upload new information into the address-book or to suggest modifications to existing information therein, etc.

More specifically, in step (C) the server receiving navigation commands from the device, and the commands are for navigating within the address-book—relates to user choices that are characteristic of the structure of the address-book, of the structure of the records therein, and or tools that may be provided for helping a user to more quickly find and utilize the contents of his address-book. For example, the address-book may be tabular, cyclic, hierarchical, or of a complex structure that is made transparent via general purpose or structure specific search engine query function(s), and the likes. Typically the commands are via a keypad of the user's device—but there are also embodiments where the device interprets voice commands of the user—or equivalently where the server interprets voice commands of the user.

More specifically, in step (D) the server sending at least one portion of a record in the address-book to the device, and the server arranging for the at least one portion to be sent in a format readable by the visual-interface-enabled voice-network-operative telephone device—relates to either (I) the server accommodating a predetermined format specification for sending data (that the user device can best accept) or (II) the server interfaces with another server, which is not part of the central address-book, and which is used to send data that the user device can best accept—and the central address-book server gives that server the record it would like to have sent to the user device in a format readable by the user's device (and the server used to send the record to the device in a format readable by the device is located anywhere between the central address-book server and the device) or (III) the user device accommodating receiving data in a predetermined format specification that the server uses for transmission, or (IIII) in conjunction with some bandwidth restrictive aspect of the interconnection between the server and the device—or (IV) with respect to a memory or buffer capacity of the device; or (V) a combination of any of the aforesaid. Illustratively, in another implementation, the phone device includes a cache for the purpose of making the navigation of the central address book faster. A predictive software located either on the phone, or on the central address book server or on both the device and the server attempts to predict what other records will the user ask for and those records predicted by the software to be asked for by the user are delivered to the phone and kept in the phone's cache (or memory or the like). Those records that were not asked for by the user at that point in time may or may not be presented to the user on the phone's screen depending among other things how large the phone screen is (whether for example the screen could accommodate more than one name and number). If afterwards the user asks to see the records predicted by the software, instead of sending the navigation command made by the user out of the phone to the server, the phone simply pulls the requested record from the cache (as it was already placed in the cache by the predictive software previously) and presents it on the phone's screen, resulting in a faster navigation experience of the address book for the user (note that such an implementation requires another piece of software on the phone that will monitor the navigation commands entered by the user and before sending the commands to the server checking whether the requested records are already in the phone's cache). An example of a prediction possibly made by such a software, if the user has asked to receive the next record in an alphabetical order, the software will arrange for the delivery of not only the record the user asked for but also for the 2 records following the record he asked for in an alphabetical order since the software will assume that the user will likely ask for those records as well. In another example, if a user types the letters making up the last name of a person he would like to call, beyond the home number record of that person that is sent to the phone in one possible implementation, the predictive software will arrange also for the work phone number, cell phone number and instant messenger username records to be sent as well.

More specifically, in step (E) the server accepting a communications command from the device, and the communications command is to establish a voice communications or a voice connection to an electronic address associated with a record of the address-book—relates to the user via his device instructing the server to place a call to an electronic address associated with a record of the address book wherein the electronic address could be a phone number or an instant messenger username associated with the name of the person the user would like to call (e.g. instruction to dial either to a telephone number or to an instant messenger used by the party being called etc).

It should be noted that in a different instant invention implementation, the server could accept a communication command from the user using his phone device not to establish a voice communication as in the above Step (E) but a communication command to include an electronic address associated with a record of the address book in a message and send the message. For example, the user may order the server to include an electronic address associated with a record of the address book wherein the electronic address could be a phone number or an instant messenger username or an e-mail address associated with the name of the person the user would like the server to send a message to (e.g. instruction to the server to send a SMS message to the associated telephone number or send an instant message to the associated username or send an e-mail to the associated e-mail address). The user in one implementation would first write the message, whether a SMS or an e-mail or an instant message and then connect to the central address book server, find the person he would like to send the message to and the server will send the message, which it will receive from the phone, to the electronic address associated with the user. The server will choose the appropriate address either because the user would point it out that it should be an e-mail address for example or based on the kind of message the user would like the server to send the server will choose which electronic address to use by it self. For example for a SMS message the server will automatically choose the phone number associated with the person the user would like to send a message to, with an instant message the server will automatically choose the instant messenger username associated with the person the user would like to send a message to and with an e-mail message the server will automatically choose the e-mail address associated with the person the user would like to send a message to. Obviously, when the server will receive such a communication command, it will not establish a voice connection as describe in detail below as step (F), but instead will send the message to the electronic address associated with the person the user would like the message sent to. It should further be noted that while a SMS could be sent either from a phone or from a phone connected to the web via a web based application, and an instant message could be sent from a phone either as a SMS or from a phone connected to the web via a web based application and an e-mail message could be sent from a phone connected to the web, having a SMS or an instant message or an e-mail sent from a server the phone dials to in order to find the electronic address associated with the person the user would like to send the message to, is unique and novel as it is different from the way those messages are currently being sent with a web based application where the phone connects to a server that provides internet access and through that server accessing a web site located on a server somewhere on the web and sending the message through the web based server. Obviously, sending the message using the central address book server could be faster than doing it via connection to the web.

More specifically, finally in step (F) the server establishing the voice connection connecting the device to the electronic address—relates to the user (that is after all already connected to the server) using the server to establish a telecommunications event to the electronic address selected from the address-book. This does not preclude the user device from making direct use of the electronic address—if it was transmitted to him. This really illustrates that there are at least two basic user interface formats for interactions between the user device and the server. According to one embodiment of the instant invention, the server only sends information to the device that will help the user determine that he has selected an appropriate record of his address-book and that he has selected a viable modality for a transaction there from—and with that, the server completes the transaction (e.g. places the telephone call, email, SMS, or the likes) while the user device has never received the electronic address data contained in the record (for example, the user chooses to call John Smith's home. While ‘John Smith Home’ appears on the phone's screen, John Smith's home phone number does not appear on the phone's screen and it may not be necessary for it to appear on the screen as the server is the one dialing to John Smith's home, not the user). Thus, it is reasonable to consider that there is one instant variant where the user sees only the information that will help him decide to have a call placed from the server, and another instant variant where the user prefers to see the electronic address, telephone number, or the likes.

According to a more relaxed protocol for server device interactions, the device received at least some electronic address data—so that in this interaction the device may establish the transaction directly to that electronic address (i.e. not via the server); or at least in some future event, the device may do so directly—without need for a redundant query of the address-book. Of course market forces dictate if it would be advised to place the call or establish the transaction directly from the device or via the server. Nevertheless, often the user places a high value on convenience, so the user may even prefer to use the server based interconnections facilities just because he is already connected to the server and perhaps the server's GUI is more facile than that of the user's device.

Simply stated, embodiments of the instant invention intend to overcome the limitations of current offered address-books over most available phone devices. Those limitations are:

### (1) It is difficult to enter letters on phone devices with no keyboards (and therefore difficult to enter names of people in an address-book)

### (2) Most phones cannot store large address-books in memory (due mainly to price)

(3) Access to web based address-books that could enable the usage of cheaper phones (less memory required to hold large address-books) as well as enable people to enter their address-books over the web which is much simpler than doing it over the phone's dial pad, require phones that are capable of accessing the web, payment for web access and the user experience is not as simple or easy as picking up a phone, finding a person in the address-book and dialing the number as it requires a few more steps at least—connecting to the internet from the phone, finding the web based address-book and then either disconnecting from the internet and calling the found number (the person the user would like to call) or calling the person over the web via a web based application usually offered in conjunction with the web based address-book (such as Skype).
(4) Finding and calling a phone number in a central address-book (whether the address-book is a company's address-book or a personal address-book uploaded via the web etc) using voice commands and/or a phone's keypad over a voice line when the system responds with voice output via the phone's audio interface is tedious and cumbersome. Mainly because it takes a longer time to listen to a system's voice response than simply to see the response on a visual screen. Also when hearing the system's response, one second of the user not being concentrated and he might miss a word that he was told by the system and now has to ask and then listen for the answer (or sometimes the entire possible menu) again. Also, voice commands are hard to decode and therefore result in a high error rate where the system does not understand the command or the name of the person the user would like to reach and only when the user hears the name the system decoded from his voice does he realize that the system made a mistake.

As most residential phones and cell phones (and other kind of phones) do not have keyboards, it is difficult to enter letters and names of people into their address-books.

As most residential phones and cell phones (and other kind of phones) do not have internet connection, they could not be used to access web based address-books.

As listening to a system's voice response given via the phone's audio interface is tedious and cumbersome, navigating an address-book where the system responds with voice is not a desirable option.

As storing large address-books on phones require expensive memory and hardware as well as in many cases expensive synchronization software and cable to synchronize the phone's address-book with a personal computer's address-book, this option is also not desirable for most consumers.

It should be noted that even the users of portable computer-phones that do have keyboards and internet connection such as the Treo and the Blackberry, mostly use the phones' address-books (the address-books stored on the phones), which they synchronize with their personal computers address-books and do not use their internet connection to find a number on a web based address-book and call it due to the fact that it is not as easy and fast as using the phone's own address-book.

The question is—is there a solution that could enable the users of most available phones to benefit from an easy and fast access to their personal address-books using their current devices?

The instant invention preferred embodiments provide the solution.

Most phones (both residential phones, cell phones and other phones) have a caller ID screen that enable them both to see who is calling them when the phone rings (function called ‘Caller ID’) or see who is calling them while they are already speaking on the phone (function called ‘Call Waiting Caller ID’). Both Caller ID and Call Waiting Caller ID deliver the following on the phone's caller ID screen:

The name of the caller appears with his telephone number or just the telephone number of the caller appears if the phone service provider can not find the name of the owner of the phone number in public records databases.

According to the preferred embodiment of the instant invention—Finding and calling a record in a personal address-book located on a central server using a visual display based phone device over a voice line:

A user makes his personal address-book available over the web to the server of the company offering the central address-book service.

The user makes his address-book available to the server by either e-mailing his address-book to the server or uploading his address-book file to the server (the file could be maintained from a software such as Microsoft Outlook or a Yahoo web based address-book for example) or providing the server with an access to a web based address-book the user is already using such as the Yahoo address-book or the Skype address-book etc (by providing the server with his user name and password for such web based address-book for example) or by entering and/or editing his address-book via a web based interface provided by the central address-book server.

The address-book server may therefore keep a copy of the subscriber's addresbook and enable the subscriber to update the copy either directly using a web interface or via an agent software located on the subscriber's PC or through other ways or the server may have access to a web based address-book that the consumer will be assumed to keep up to date. The server may access the web based address-book every time the user dials to the central address-book server (or when the user access the central address-book server in a different way) or the central address-book server may access the web based address-book from time to time and make sure that it has the most up-to date copy of the user's address-book or if the company providing the user with a web based address-book (such as Yahoo) works with the central address-book provider (such as Verizon) a different integration might be agreed upon where the web based address-book used by the user sends updates to the central address-book server whenever the user adds, deletes or edits records in his address-book.

Whenever a user would like to call someone in his central address-book, using his phone he dials to the central address-book server. The central address-book server could be accessed by the user dialing a full number of the server or if the central address-book service is provided by the company providing a phone service to the user, the user could dial *8 for example or something else (the same way a user will dial *9 from his home phone and get access to the voice mail service he is receiving from his phone company or the same way a user dials ‘1’ on his cell phone and the cell phone connects him with the voice mail offered by his cellular carrier). The dialed keys (*8 or something else) will be recognized by the phone company that would then connect him with the central address-book server.

Upon connection to the central address-book, the server will recognize the user according to the phone number he called from and the digits it used to connect to the service or the phone number he called from and PIN code or by the user entering his home phone number and a PIN etc. For example, a swift and immediate access to a person's address-book could be provided by the server when the subscriber calls the server from the telephone number that subscribed to the service, where the calling from the home telephone number could be accepted as a permission from the user to the server to give the caller an immediate access to the address-book of the person that subscribed to the address-book service from that home without asking for a password such as a PIN (PIN, a Personal Identification Number could be a 4 digit combination such as 1234). If several people in the same household subscribed to the central address-book service, then if *8 for example was dialed from the home, the combination of the telephone number from which the call originated and the *8 dialed from the home would lead the server to provide access to the address-book of the first person that subscribed to the service from that home. If *7 for example was dialed from the home, the combination of the telephone number from which the call originated and the *7 dialed from the home would lead the server to provide access to the address-book of the second person that subscribed to the service from that home.

The central address-book once recognizing the subscriber, sends to the phone the subscriber is using either the name of the person's address-book (‘John Smith's Address-book’) or the first record in the address-book (for example ‘John Adams, 212-219-1234’).

The server takes advantage of the phone's support for ‘Call waiting caller ID’, which is the phone's ability to receive a text indicating who is calling the user while he is already on a call using the phone (telephone number of caller and his name if available in public records) to send the address-book records to the phone. Obviously the server could take advantage of other phone functionalities that enable it to receive and present text on the phone's screen while the user is on a call (the user needs to be on a call in order to send instructions to the server how he would like to navigate the address-book as well as instructions which record should the server connect it with for example).

Alternatively, the user may send instructions how he would like to navigate the address-book as well as instructions which record should the server connect it with via SMS (Short Message Service) and also receive the records he asked for via SMS but this implementation might not be as user friendly and fast as the one the user dials to the server and receives immediate responses to his commands.

In one preferred implementation, the user dials to the server and the server in order to send an address-book record to the phone will interface with the servers of the phone company providing the user with his phone service.

Through this interface the central address-book server informs the phone company server to send to the user the address-book record (which could include name only, or name+telephone number, or telephone number only or name+instant messenger user name or any combination of letters and digits) in such a format where the user's phone will receive the address-book record and present it in a similar way to the way a call waiting caller ID would have been presented for example on the phone. More detailed examples of such implementations will be given later.

The user when receiving address-book records on the phone's screen can send the server instructions how would he like to navigate the address-book or which record would he like the server to connect it with. The instructions are sent via digits pressed on the phone's keypad for example and sent as DTMF for example to the server or as voice commands in another implementation.

For example, pressing of the * key on the phone will cause the central address-book to send the next record. If pressed at the beginning of the connection to the central address-book server then the first name in the address-book will be sent to the phone and appear on the screen (assuming that the first text to be sent to the phone is the user name—‘John Smith's Address-book’ for example and not the first record). If pressed later on then simply the following record in alphabetical order will appear. If the # key is pressed then the previous record will be sent by the central address-book server. If the digit 1 is pressed then the record is chosen. If the record is a name of a person then the next screen will show the person's work phone number, followed by a * key and then the person's mobile phone etc. If the digit 1 is pressed when the phone's screen shows an actual phone number (with or without a name) then that phone number will be dialed by the central address-book server and the user will be connected with his desired destination. Alternatively, if the digit 1 is pressed when the phone's screen shows an instant messenger user name then the central address-book server will connect the user connected to the central address-book server with the desired party by calling that instant messenger's user (assuming that this instant messenger supports VOIP calls as most instant messengers today such Skype and Yahoo do).

A name could easily be found faster by dialing the first letters of the person's last name using the dial pad. The central address-book in return will show all the names that have the pressed digits possible letter combinations sorted in an ascending alphabetical order. The user can then browse through the sorted results by pressing * (next name) or # (previous name). If a name was chosen by pressing 1 and the user realizes he made a mistake (he sees the work telephone number of the person he chose on the screen) and would like to go back one level to the sorted results then he would press 0. Pressing 0 always gives the user the previous level wherever he is in the address-book (the address-book is like a tree in one implementation).

Obviously the above is only one implementation of the way the address-book could be navigated and other digits could be chosen as representing instructions to the address-book server based on the preference of the company offering the central address-book service or the preference of the user.

The user may choose to have his address-book presented in a one level tree where a person's work number will appear as the next record in alphabetical order after the person's home number or the user may choose to have the address-book as a multi level tree where people names will appear in the first level and the user would have to go down one level (i.e. choose a name of a person he would like to reach by dialing ‘1’ for example) to see the different telephone numbers of that person which will be leafs of the chosen person in a tree implementation (work number, home number, cell phone number, instant messenger ID etc).

Once again the above is just an example, the address-book may be organized in different ways where a tree is only one implementation.

The instant invention Central Address-book server can also provide users with Speed dial for desired records. The user may designate specific phone numbers with speed dial digits via a web based interface for example.

The user may pick his phone, hear a dial tone on a residential phone or simply dial on a cell phone and access the Speed dial of the central address-book directly by dialing *82. The *82 will both connects the user to the address-book (the *8) as well as immediately connect him to his desired destination (speed dial 2) while showing on the phone's screen the name & telephone of the party being called (to which speed dial ‘2’ was assigned to).

Alternatively, the user may dial to the address-book server and then press **2 to have the server connect him with the telephone number he associated to the server with speed dial ‘2’.

While the user is navigating the central address-book, incoming calls will appear as usual on the screen of the phone and since this will not be correlated with the records the user asked from the central address-book to send, the user will understand it is an incoming call he can answer if he wants. Alternatively, the incoming call will appear with a ## at the beginning to clearly mark the call as an incoming call.

The instant invention Central Address-book service could be offered by phone companies offering POTS or VOIP or cellular service. The central address-book may also be offered by Skype or Yahoo or any other portal or company that offers a web based address-book and VOIP calls over their IM (Instant Messenger) or web based calling service as a method to let subscribers benefit from their web based address-book in a convenient way as well as possibly low cost long distance calls to their destination from their non-web connected phones.

The subscriber will dial the Yahoo central address-book server over a voice line for example, find the person he would like to dial to in the Yahoo address-book server (he could also use speed dial over the Central Address-book) and Yahoo will connect the user to his destination. Companies that offer pre-pay calling or calling cards could also benefit from the service. All the above examples obviously not limiting other companies not mentioned above to offer the service.

The instant invention Central Address-book may also be used to improve the public address-book records used by phone companies for caller ID. For example, in the US, cell phones owners are not registered in public databases and therefore when they call, only their telephone number appears without their name. If a telephone provider will also pull addresses from the central address-book of the subscriber who is receiving a phone call, it could show on the caller ID screen the name of the person as it appears in the central address-book and not the name as it appears in the public address-book (or does not appear in the address-book at all if it is a cell phone).

The instant invention central address-book may also be used for personalization purposes. A user may choose to assign different distinctive rings to different people within his central address-book. A phone provider offering the central address-book could ring the user's phone with the distinctive ring assigned by the user to the person calling him. A user may choose to replace the ringing tone people hear when they call him till he picks up the call with a song where different people in the central address-book will be assigned different songs to hear when they call the user till he picks up the call or his voice mail picks up the call.

The instant invention central address-book could be used by a software agent on a phone to copy the central address-book or sync with it. A new cell phone could call the address-book and a software installed on the cell phone could record the book (or part of it) to the cell phone by going through the central address-book records. It should be noted that this feature might be less common as most low priced cell phones would not accommodate too many addresses in their local address-book and could not accommodate a large address-book. Also, it will require people to use a software on the phone to do it while the central address-book does not require them to do so and therefore is simpler to use, and ease of use is very important in consumer products.

Sending Address-Book Records to Phones with ‘Call Waiting Caller ID’ Functionality—

While the phone ‘thinks’ that it is a call waiting caller ID, in reality it is the same server the phone dialed to in order to get access to the address-book that arranges for the sending of the address-book record requested by the user and not another party that calls the phone while he is already on a call with the central address-book server. The central address-book server arranges for the sending of the requested record either by integrating with the phone provider server or through a different way, with the same outcome in this proposed implementation—the sending of the address-book record without initiating another call to the phone.

The examples below are of possible instant invention implementations with POTS landline phones.

Bellcore has defined three CPE (Customer Premises Equipment) types: Type 1 is for interfacing to on-hook CLASS services {Custom Local Area Signaling Services—are PSTN telephony intelligent network services beyond simple voice transfer, such as caller ID (automatic number identification (ANI)), caller number blocking, automated call return, call blocking or screening, TCAP services, etc.} such as Caller-ID (CID), which may include the Calling Name information (CNAM), and the Visual Message Waiting Indicator (VMWI) feature. Type 2 is CID and/or CNAM but the feature works while off-hook in conjunction with the Call Waiting feature. This is called Caller-ID on Call Waiting (CIDCW) or Call Waiting Caller ID. Type 3 is for interfacing to features using the Analog Display Services Interface (ADSI) protocols. A Type 2 CPE must be capable of interfacing to Type 1 and Type 2 features. A Type 3 CPE must be capable of interfacing to Type 1, Type 2, and Type 3 features.

### Type 1 Features (CID, VMWI)

On-hook CID (number and/or name) is transmitted on the telephone line between the first and second power ringing signal. The data is transmitted via Frequency Shift Keying (FSK) modulation. The longest silent interval (between cycles) is when FSK data is transmitted. The CPE is required to receive the FSK, decode it and display the information as appropriate.

### Type 2 Features (CIDCW)

The CIDCW feature is used to transmit the same information as the on-hook CID feature except in this case the customer's current call is interrupted while the data is transmitted to the CPE. This interruption is started by the Stored Program Controlled Switching System (SPCS) by transmitting a Call Waiting signal (440 Hz, about 300 ms) followed by a CPE Alerting Signal (CAS). The CAS is what is detected by the CPE. Upon detecting the CAS the CPE is to mute the CPE handset (transmitter and receiver), or speakerphone microphone and speaker, send a DTMF Acknowledgment signal (ACK) and wait to receive the FSK. If a time-out occurs after sending the ACK, the CPE is to un-mute the transmitter and receiver and continue with normal operation.

### Type 3 Features (ADSI)

ADSI provides protocols that define two different types of features. One, Server Display Control (SDC) which is used for real-time connection to a server (via a regular telephone connection) or directly to an SPCS. SDC features are usually for transactions such as banking, visual voice mail, enhanced Interactive Voice Response (IVR), etc. SDC applications will display text on the CPE screen and alternately send voice to provide more instructions. The user interacts with the application by pressing softkeys which the server has programmed to perform various signaling when selected. The second type of feature is called Feature Download (FD) or Script Interpretation. FD is used to download a semi-permanent script into the telephone. The script contains information which allows the phone to track various states of calls and provide context sensitive information to the user. This will enable the user to make better use of CLASS and Custom Calling services which without FD, would require the user to remember procedures, sequences, and signaling codes. The FD script relieves the user of this burden by presenting text and softkeys that show the user which services are available and the ability to activate the service with one touch of a softkey button.

One possible instant invention implementation is for the central address-book server to integrate with the phone company's server responsible for the call waiting caller ID and through that server send the address-book records requested by the user to the user's phone by having the phone company server send the records in a call waiting caller ID format although there is no other caller calling the user who is now connected to the central address-book server he dialed to. Please note that step (D) states that the server sending at least one portion of a record in the address-book to the device, and the server arranging for the at least one portion to be sent in a format readable by the visual-interface-enabled voice-network-operative telephone device; however that one portion is sent in a format readable by the phone in many cases by the phone company's server not the central address-book server (the central address-book server arranges the sending in a format readable by the phone device by giving the phone company's server the record that needs to be sent to the phone device and the phone company's server sends the record to the phone device in a format readable by the phone device) or in some cases possibly by the central address-book server;(in this case the central address book server arranges the sending in a format readable by the phone device by converting by it self the record it would like to send to the phone device into a format readable by the phone device and sending by it self the record to the phone device in that format which is readable by the phone device) SUCH that the content is readable on the device. Specifically, this may be accomplished by a server in a communications path between the address-book server and the device.

In a different instant invention implementation, the central address-book server, instead of relying on the phone company's server to send the address-book records via FSK modulation could send itself the address-book records via FSK modulation to Type 2 phones (phones that support call waiting caller ID) by using some of the functionality of an ADSI server (the server does not need to support all of ADSI functionality as the phones them selves don't support the ADSI protocol).

The examples below are of possible instant invention implementations with VOIP landline phones.

Taking advantage of the high penetration of broadband (high speed internet access) to homes and offices, different companies started offering VOIP (Voice Over Internet Protocol) based phone lines to consumers. Consumers that sign-up for a phone service from such a provider receive an adapter which connects to their DSL or cable modem on one hand (or to a router connected to them) and enable the subscriber to plug their analog phones into the adapter on the other hand. The adapter converts voice to IP based packets and received packets to voice. Those adapters support phone features such as Caller ID, Call Waiting, Call Waiting Caller ID, Three-way calling and Call Forwarding.

As both those adapters as well as the VOIP based phone service providers support Call Waiting Caller ID, the central address-book server, in one suggested implementation, can interface with the VOIP based phone service provider's server which is responsible for the call waiting caller ID and through that server send the address-book records requested by the user to the user's phone by having the VOIP based phone company server send the records in a call waiting caller ID format although there is no other caller calling the user who is now connected to the central address-book server he dialed to.

In this implementation, the user can access his central address-book from any telephone line provided by the phone company to which the central address-book server interfaces.

In an instant invention implementation where the central address-book server does not need the cooperation of the phone company to offer the address-book service over that company's phone lines, the user may dial to that server from any line provided by the same phone company.

In one suggested instant invention implementation, the user may access his central address-book from a phone line provided by a phone company other than the phone company that provides him the central address-book service when the phone company that provides him the service either cooperates with the phone company which he is using one of their lines to access the central address-book server (by interfacing with their server which is responsible for call waiting caller ID for example) or when the phone company that provides him with the central address-book service does not need the cooperation of the phone company he is using one of their lines to access the central address-book service to provide the service.

Below are examples of possible instant invention implementations with cellular phones.

Implementing caller ID in the past was not an attractive option to cellular carriers due to the low number of handsets that supported caller ID functionality. However, today most handsets do support the display text feature required for Caller ID functionality.

One possible instant invention implementation is for the central address-book server to integrate with the cellular company's IN (Intelligent Network) server which is responsible for the call waiting caller ID functionality and through that server send the address-book records requested by the user to the user's phone by having the cellular phone company server send the records in a call waiting caller ID format although there is no other caller calling the user who is now connected to the central address-book server he dialed to.

Another possible instant invention implementation although not as preferable, while the user's call to the central address-book provides an upstream for user's commands to the server, for downstream (requested address-book records) the server will initiate another call to the user in order to take advantage of ‘call waiting caller id’ functionality of the phone without integrating with the phone company's server for example (it should be mentioned that there are also other implementations that does not require integration with the phone company that provides the user with a phone service). The server will have to initiate the call as if coming from the phone number requested by the user so the phone provider will look it up in the public database and send the name of the sent number owner along with the phone number to the phone. Obviously, this method is not preferable for several reasons:

### 1) Requires the server to initiate calls as if coming from phone numbers that are not his

2) Limits the names that could be attached to phone numbers to the names of phone owners that appear in public records used by the phone provider's call waiting caller ID service. The names do not necessarily are the ones used by the user to describe the people in his address-book. Also, as in the US cell phone numbers do not appear in public databases, the cell phone numbers owners names could not be send to the user who is navigating his phone book (that of course do include them), which is not good.
3) After several rings, the call might be transferred to voice mail and the server will have to initiate another call. If the user asks for another name in the address-book, another call must be initiated.

It should be noted that all of the above are suggested implementations. In another instant invention implementation a phone may receive the requested address-book records via a dedicated proprietary protocol.

In another instant invention implementation, the phone it self might be a proprietary phone used to receive a VOIP based phone service in a WiFi network.

In another instant invention implementation, a software might be installed on a phone with a visual interface. Once the user dials to the central address-book server, the server could send the address-book records by using an encoding technique that will translate the letters and numbers of the language (English for example) to numbers where the numbers will be sent via DTMF for example. The software on the phone would decode the sent numbers and present the sent records on the phone screen. The software on the phone could further send the navigation and communication instructions by encoding it (or simply just sending it via DTMF for example without decoding it). Such an implementation is an example of an implementation that allows the company offering the central address-book service or product to offer it without any cooperation or integration with the phone company providing the user with his phone service. Obviously, the phone company providing the user with its phone service could also use this implementation to offer the user a central address-book service or product. Such an implementation also enables the user to dial to the central address-book server and access his address-book from any phone line provided by whatever phone company.

It should further be noted that while the above description focuses on a personal address-book, in another possible instant invention implementation other address-books such as the address-books (calling directories) of companies people are calling could also be made available by the companies to users using phone devices that support call waiting caller ID. The companies will be using a server that will send the callers, who will be connected with the server when dialing to the company, the records asked by the caller in a call waiting caller ID format. The server will be sending the records in a call waiting caller ID format in the same ways the central address-book server offering users access to their personal address-book would have done so. The server would also enable a user to navigate the company's directory and call a chosen record in the same ways the central address-book server offering users access to their personal address-book would have done so.

It should also be mentioned, that one possible outcome of this invention will be phones that will have additional buttons added to them to make the navigation of the address-book easier. Instead of dialing the * key to get the next record in an alphabetical order for example, the phone will have a button with the label ‘Next’ on it. It could be that the ‘Next’ button will perform the same functionality of the * key (sending the DTMF of * when pressed) but will offer the consumer more convenience as they won't have to remember that * stands for ‘Next record’ and # stands for ‘Previous record’ for example. Obviously the buttons could represent any functionality desired from the address-book whether navigation functionality or other. A phone may also be offered for example with a larger screen so more than one name and number could appear on the screen in any given time.

Notices

The present invention is herein described with a certain degree of particularity, however those versed in the art will readily appreciate that various modifications and alterations may be carried out without departing from either the spirit or scope, as hereinafter claimed. For example, there are substantially equivalent viable embodiments of the instant invention that deviate from the ordering of the method steps as presented herein. The ordinary man of the art will readily recognize that after studying the examples herein—that one can perform substantially the same functions in substantially the same way to yield substantially the same result—without necessarily dividing those functions between the server side and the device side as outlined herein. One may configure embodiments that are virtually server side enabled and one may configure other embodiments that are virtually user device side enabled, and of course those embodiments that share the functionality there between. It would be redundant to teach all of these many combinations—since the ordinary man of the art will naturally configure them as necessary without any need for further inventive steps—and thereby arrive at a working version of the method according to the present invention.

In describing the present invention, explanations are presented in light of currently accepted Information-Technology or Telecommunications theories and models. Such theories and models are subject to changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching, the current man of the art or the current team of the art, how these embodiments may be substantially realized in practice. Alternative or equivalent explanations for these embodiments may neither deny nor alter their realization.

In the context of the present invention, a “server” is essentially a logical entity associated with at least one physical server wherein the physical server is Internet communications enabled; or wherein at least one of the at least one physical servers is Internet enabled and the remaining servers are connected there between via a substantially compatible data-communications topology infrastructure.

Furthermore, please note that in the context of the present invention, the “method” according to the present invention includes (A) the electronic embodiment of the steps outlined herein; and/or (B) a telecommunications protocol for performing these method steps—including their variations, preferred forms, and the likes—wherein the protocol is enabled partially on the server side and partially on the user device side; and/or (C) software including a program storage device readable by machine, tangibly embodying a program of instructions executable by the machine to perform method steps for locating and calling a phone number in an internet accessible address-book using a visual interface phone device wherein such software may be a contributory-to-enabling module on the server side and/or on the user device side; and/or (D) an article of manufacture and/or a computer program product including a computer usable medium having computer readable program code embodied therein for locating and calling a phone number in an internet accessible address-book using a visual interface phone device, the computer readable program code in said article of manufacture including computer readable program code for causing a computer to perform the method steps according to the present invention—substantially as herein described and illustrated.

### BRIEF DESCRIPTION OF THE DRAWINGS

In order to understand the invention and to see how it may be carried out in practice, embodiments including the preferred embodiment will now be described, by way of non-limiting example only, with reference to the accompanying drawings. Furthermore, a more complete understanding of the present invention and the advantages thereof may be acquired by referring to the following description in consideration of the accompanying drawings, in which like reference numbers indicate like features and wherein:

FIG. 1 illustrates a schematic view of the method for locating and calling a phone number in an internet accessible address-book using a visual interface phone device according to the present invention; and

FIG. 2 and FIG. 3 respectively illustrate schematic views of two alternative scenarios for enabling modes of the instant invention.

### DETAILED DESCRIPTION OF THE INVENTION

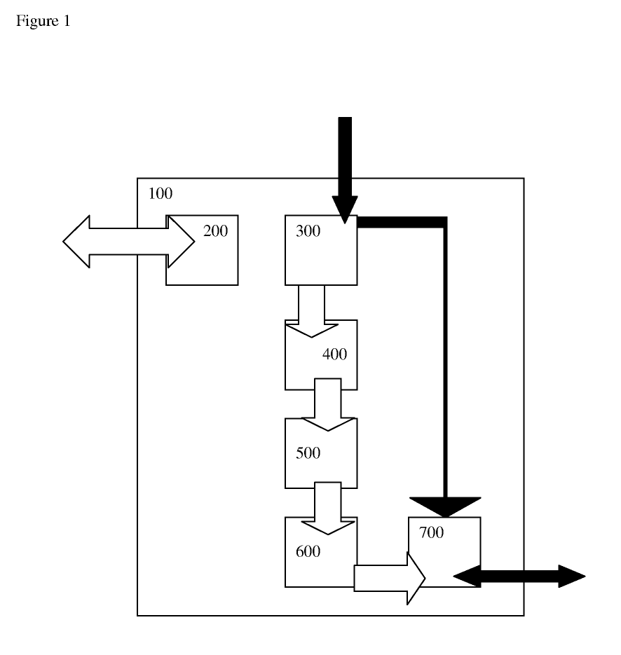

Now, as described above and in particular in the “Brief Summary Of The Invention” section, the present invention relates to embodiments of a method for (as a non-limiting example) locating and calling a phone number in an internet accessible address-book using a visual interface phone device, which is navigated via a visual-interface-enabled voice-network-operative telephone device. Turning to FIG. 1, these embodiments of the method according to the present invention are including the steps: (A) a server 100, via Internet, receiving 200 access to a user's address-book, wherein the address-book has more than one record; (B) the server accepting 300 a dial-up connection from the user, wherein the dial-up is from a visual-interface-enabled voice-network-operative telephone device, and wherein the user is selected from the list: an owner of the address-book, or another a party satisfying approval criteria of the owner; (C) the server receiving 400 navigation commands from the device, and the commands are for navigating within the address-book; (D) the server sending 500 at least one portion of a record in the address-book to the device, and the server arranging for the at least one portion to be sent (so that it will arrive) in a format readable by the visual-interface-enabled voice-network-operative telephone device; (E) the server accepting 600 a communications command from the device, and the communications command is to establish a voice connection to an electronic address associated with a record of the address-book; and (F) the server establishing 700 the voice connection connecting the device to the electronic address.

According to a first embodiment variation of the method according to the present invention, the step of receiving access to a user's address-book includes the server accommodating a user provided copy of the address-book, and the accommodating is accomplished between the user and the server via the internet. This accommodating relates to other variations for the sharing and/or copying of data from the address-book (which may reside on the server of the instant method or will reside on some other server that provides access to the address-book). These accommodations substantially relate to issues like the security and integrality of the address-book, such as often occur for ordinary users who may maintain complete or partial copies of their address-book on cellular telephones, advanced POTS devices, personal electronic notebooks, other server side storage facilities, and the likes—all of which introduces complexities of synchronization of data, resolution of version discrepancies, and the likes. For example, the device per se may exploit its server side connection to both place a call (or transaction) and concurrently introduce new details into the address-book. This scenario is typical for a case where a user is making a first call to a new number and therewith creating an association with an established or a new record of the address-book.

According to a second embodiment variation of the method according to the present invention, the step of receiving access to a user's address-book includes granting to the server access to an Internet based address-book. This substantially relates to a different security aspect of the instant invention wherein a user requires permission or authorization or identity verification. This aspect may also include password codes, callbacks, encryption activities, or the likes.

Now according to a form of the second embodiment, the step of granting the server access includes using a predetermined Internet communications protocol schedule for updating the address-book from an internet-accessible substantially most up-to-date version of the address-book. A good utilization for the address-book occurs when a user dials up to the server. However, proactive automatic transactions may occur automatically from the user device, on a predetermined schedule, according to a predetermined threshold of necessity to initiate synchronization or updating or archiving, or the likes. For example, a user capturing new contact information on his device may reasonably expect that his device will be smart enough to find an opportunity to communicate this new content to the address-book. Thereafter, when the user accesses his address-book, he may find that there are incomplete new record(s) that could be improved with his attention to providing additional details.

According to a third embodiment variation of the method according to the present invention, the step of accepting a dial-up connection includes the server accessing an internet-accessible substantially most up-to-date version of the address-book and incorporating heretofore-unincorporated updates that have been made thereto. Just as the aforementioned transactions like activities may occur by user device initiation, there are other embodiments where these data management tasks are dominated by server side initiatives.

According to a fourth embodiment variation of the method according to the present invention, the step of receiving navigation commands further includes the server accessing an internet-accessible substantially most up-to-date version of the address-book and presenting content therefrom to the user

According to a fifth embodiment variation of the method according to the present invention, the step of accepting a dial-up connection includes accepting transmissions of communications occurring over a protocol selected from the list: an SS7 protocol, a Cellular telephone protocol, a VOIP protocol, and a POTS protocol. This returns to a basic concern motivating many aspects of the instant invention—as noted in the background of the invention discussion. Specifically, there will remain a disparity between the bandwidth of inter-server communications and device with server dial-up communications. Some of the embodiments of the instant invention therefore accommodate linkages that are bandwidth restricted.

According to a sixth embodiment variation of the method according to the present invention, the step of receiving navigation commands from the device includes interpreting a navigation command that corresponds to a user pressing at least one key on a keypad of the device.

According to one arrangement, the commands are intuitive to the keypad—such as using an upper key to scroll record up, a lower key to scroll record down, left to pan left within a record, right to pan right within a record, a central key to select; and perhaps peripheral keys for editing functions. Other arrangements may use a prefix to activate a search engine, and thereafter to scroll within the search results, etc.

Now according to a preferred form of the sixth embodiment, the step of interpreting a navigation command includes accepting transmissions of communications encoded as DTMF. This form specifically relates to a typical bandwidth restrictive case, which is a goal of the instant invention to adequately teach.

According to a seventh embodiment variation of the method according to the present invention, the step of receiving navigation commands from the device includes interpreting voice commands of the user. Voice commands could be accepted instead or in addition to commands given via the keypad. The voice recognition may be on the device or on the server.

According to a eighth embodiment variation of the method according to the present invention, the step of sending at least one portion of a record in the address-book to the device includes sending of the said at least one portion in a format readable to the phone device as a ‘call waiting caller ID’.

According to a ninth embodiment variation of the method according to the present invention, the step of accepting a communications command includes interpreting a communication command that corresponds to a user pressing at least one key on a keypad of the device. This is a similar facility to that described in the sixth embodiment variation.

Now according to a preferred form of the ninth embodiment, the step of interpreting a communication command includes accepting transmissions of communications encoded as DTMF. Furthermore, this is a similar facility to that described in the preferred form of the sixth embodiment.

According to a tenth embodiment variation of the method according to the present invention, the step of accepting a communications command includes interpreting a voice command of the user. This is a similar facility to that described in the seventh embodiment variation.

According to an eleventh embodiment variation of the method according to the present invention, the step of establishing the voice connection includes the server dialing up the electronic address and thereby connecting the user to an entity corresponding to an electronic address in a chosen address-book record. Returning to the background of this instant invention, we find that the convenience of continuing from the server based address-book query activity to the initiation of a transaction from the server provides a great simplification for the user convenience—among other reasons because the server may be enabled to select most economical conduits for completing the transaction initiation—such as by selecting a least expensive service provider.

According to a twelfth embodiment variation of the method according to the present invention, step of establishing the voice connection includes selecting a linkage compliant with the electronic address and the electronic address is selected from the list of types: POTS linkage, VOIP linkage, cellular telephone linkage, wireless pager linkage, e-mail linkage and SMS linkage.

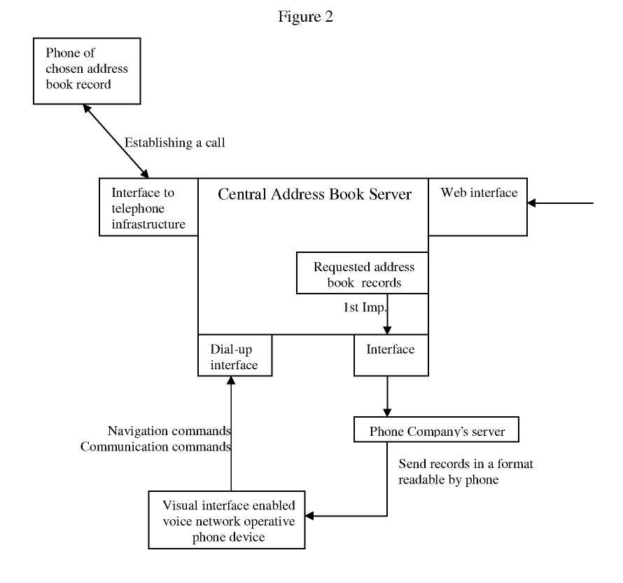

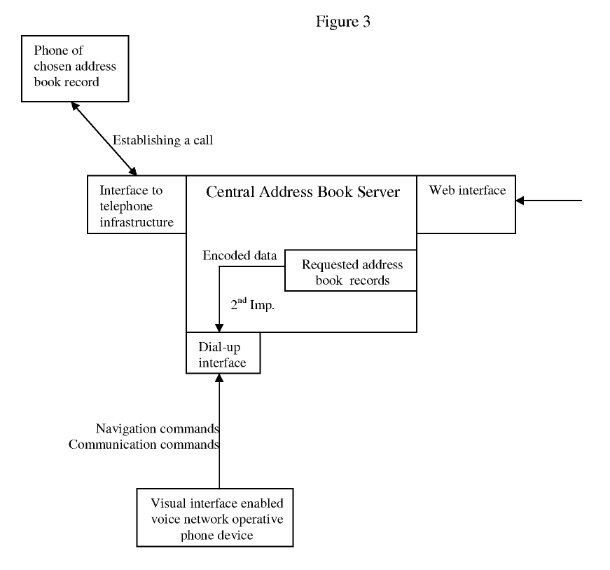

Now, FIG. 2 and FIG. 3 describe two possible enabling implementations (‘Imp.’) out of many possible embodiments of the instant invention.

In the 1^{st} suggested implementation (FIG. 2) the Central Address Book Server interfaces with the phone company's server and arranges that the phone company's server will send the address book records requested by the user to his phone in a format readable by the phone.

In the 2^{nd} suggested implementation (FIG. 3) the Central Address Book Server sends by him self (without interfacing with a phone company's server) the user requested address book records in a format readable by the phone. In this suggested implementation the Central Address Book Server encodes the records, sends the encoded data using DTMF and the phone decodes the data using a decoding software on the phone and presents the sent record on the phone's screen.

Now, while the invention has been described with respect to specific examples including many presently preferred modes of carrying out the invention, there are a few important variations, which deserve discussion in greater detail. By way of non-limiting examples, those variations include the Contacting of an Address-book server either by a subscriber dialing-in to the server or a call, e-mail or SMS intended for the subscriber going through the Address-book server, the Address-book server based on real-time commands (real-time instructions) given by the subscriber or pre-defined rules (pre-given instructions) given by the subscriber Routing a call, e-mail or SMS to its destination where the destination is a device or e-mail address or voicemail either of the subscriber when the server routes a call, e-mail or SMS intended for the subscriber or of the person the subscriber would like to contact when the server routes a call, e-mail or voicemail based on real-time commands given by the subscriber.

In all of these variations, we are coordinating an activity with the CAB of the instant invention. This activity may be using the CAB to help send and/or transform content to at least one “address” in the CAB. This activity may be using the CAB to help receive and/or transform content from an “outsider” who is trying to send content to the CAB user (or to more than one CAB user—in the event that is a group property). Content means audio, visual, alphanumeric, or combinations—in the format of an electronic transmission (generally digital but occasionally still analog or mixed). Transform means conversion of voice to text, or of text to voice, or of visual representation to labels, or of label to visual representation. Transform may also mean conversion of email to SMS, or of SMS to email, or of voice-mail to text-mail, or between any two electronic message formats. Send means transmitting an email, SMS, voice connection, or the likes as appropriate. Receiving means accepting an email, SMS, voice connection, or the likes as appropriate—and may including a routing “protocol” which determines an appropriate combination of transformation and/or further sending.

While a communication command could be, for example, to establish a voice connection as already described in details, a communication command could also be to send a voice message to an e-mail. Executing a communication command may therefore include sending an e-mail to an electronic address delivered to the device by the server. Executing the communication command may include recording a voice message from the user and at least one operation selected from the list: (A) sending the voice message in an e-mail to the desired e-mail address; (B) sending the voice message in an e-mail as an audio file attachment; (C) translating the voice message into text and sending the text in an e-mail to the desired address. In addition, the sending of the translated voice message may include one or more of the following: (1) reviewing the translated voice message by the device user prior to being sent; (2) reviewing the translated voice message by sending the message text to the device screen; (3) reviewing the translated voice message by sending the text to the device phone screen using call waiting caller ID protocol; (4) reviewing the translated voice message by having the server vocalize the translated message; and (5) reviewing the translated voice message by sending the message text to the device and by having the device vocalize the translated message. Executing a communication command may include sending to an electronic address an item selected from the list: SMS, voice mail; e-mail, a voice to text content, and a text to voice content.

Furthermore, for example, executing the communication command may include: recording of a voice message from the user and sending the voice message to an e-mail address; recording of a voice message from the user and sending the voice message to an e-mail address as an audio file attachment; or recording of a voice message from the user transforming the voice message into to text and sending the text to an e-mail address. Text transformed from a voice message may incur an extra operational event such as sending the text back to the device and accepting a text approval or a text amendment from the device user; such that the text sent to the email address is approved or amended. The text could be sent to the device for approval by either arranging for the text to be sent to the device in a format readable by the device so it could be presented on the device's screen to the user for approval/amending or the text could be transformed into a vocalized version and the user could hear the text on the device and decide whether to approve it, rerecord the entire message or amend it. Once the user approves the text translation of his voice message (whether immediately after hearing the first translation or after rerecording part of the message or amending the message text using the phone's keypad etc), the text is sent via e-mail to the desired e-mail address.

A communication command could also be broadly defined as a request to the server to establish a “data transmission” to an electronic address associated with a record of the Address-book. The server establishing the data transmission may include any of the following (A) the server sending a device specified message selected from the list: voicemail, email, SMS, audio content, visual content, alphanumeric content, and any combination of the aforesaid; (B) using a device specified electronic address type selected from the list: email address, telephone number, and voice mailbox number; (C) accepting voice content from the device and converting the voice content into substantially equivalent alphanumeric content; (D) sending the message to multiple recipients designated by the device user; (E) sending a device specified return reply address; or the likes.

More specifically, according to a thirteenth instant embodiment, the interacting construction of the instant invention relates to a general method for interacting via an internet accessible Address-book using a visual interface phone device, wherein the Address-book is navigated via a visual-interface-enabled voice-network-operative telephone device, the method including the steps:

### (A) a server, via Internet, receiving access to a user's Address-book, wherein the Address-book has more than one record;

### (B) the server accepting a dial-up connection from the user, wherein the dial-up is from a visual-interface-enabled voice-network-operative telephone device;

### (C) the server receiving navigation commands from the device, and the commands are for navigating within the Address-book; and

### (D) the server sending at least one portion of a record in the Address-book to the device, and the server arranging for the at least one portion to be sent in a format readable by the visual-interface-enabled voice-network-operative telephone device.

However, in particular (mutatis mutandis—as has been described in great detail above), the instant method further includes the following steps: (E) the server accepting a communications command from the device, and the communications command is to establish a voice connection to an electronic address associated with a record of the Address-book; and (F) the server establishing the voice connection. Thus, the server might be used to navigate a centrally stored address-book only or to further contact a person whose contact is in the address-book.

Now, mutatis mutandis, the “contacting” variant embodiments and the “routing” variant embodiments, which will forthwith be described in detail, are really corollary variants of the interacting construction embodiments; and are likewise amenable to the respective extensions that have been described in great detail above.

Specifically, according to a fourteenth instant embodiment, the Contacting and Routing of the instant invention relates to embodiment of a method for locating and establishing a data transmission in an internet accessible Address-book using a visual interface phone device, wherein the Address-book is navigated via a visual-interface-enabled voice-network-operative telephone device, the method including the steps:

### (A) a server, via Internet, receiving access to a user's Address-book, wherein the Address-book has more than one record;

### (B) the server accepting a dial-up connection from the user, wherein the dial-up is from a visual-interface-enabled voice-network-operative telephone device;

### (C) the server receiving navigation commands from the device, and the commands are for navigating within the Address-book;

(D) the server sending at least one portion of a record in the Address-book to the device, and the server arranging for the at least one portion to be sent in a format readable by the visual-interface-enabled voice-network-operative telephone device; and the method further includes

### (E) the server accepting a communications command from the device, and the communications command is to establish a data transmission to an electronic address associated with a record of the Address-book; and/or

### (F) the server establishing the data transmission.

Thus, once the user presses ‘1’ in response to a contact e-mail on the phone's screen for example, the server does NOT have to send another text to the phone via CWCID but lets the user record a voice mail. However, the server might optionally send a text message to the phone's screen stating—“please record the message”, in which case there are further text messages sent by the server to the phone's screen after receiving a communication command from the device.

This fourteenth embodiment is related to using the “Central Address-book” to send voicemail to an e-mail address or to a telephone number or to a voicemail-box. For example, a user has an option of sending a voicemail to a contact e-mail. While e-mail is a convenient way to communicate, it is much faster to communicate a message using voice than using a keyboard to type it. This “Central Address-book” actualizing embodiment provides users with the combined strength of e-mail and voice communications; by enabling a user to send a voicemail to a contact's e-mail address. Once a user has a contact's e-mail address on the phone screen, then the user can press the digit ‘1’ and be prompted to record a voice message that will be sent to the desired e-mail address. Alternatively, a typical first thing the user is asked to do when connected to the CAB is to choose whether he wants to ‘make a call’, ‘send an e-mail’, ‘send a SMS’, ‘send a fax’ etc. If the user chooses to ‘send an e-mail’ option for example he could simply navigate the CAB records that include e-mail addresses. The CAB could deliver to the device only the names of the people in the address book that have e-mail address associated with them without sending the actual e-mail addresses to the device or the CAB may also send the e-mail addresses to the device. Once the user chooses a person he would like to send an e-mail to or an e-mail address he would like to send an e-mail to, by pressing the digit ‘1’ for example when they appear on the device screen, the user would be prompted to record a voice message. The user can record and review the voice mail prior to sending it. The e-mail with the attached voice message (the voice message could be attached to the e-mail as an audio file) could be sent from the “Central Address-book” e-mail address ‘on behalf of Mr. User’ or could be sent by the “Central Address-book” server using the user's e-mail address to enable the e-mail recipient to reply directly to the user. To prevent fraud, the “Central Address-book” will ask a user to confirm ownership of his e-mail address by entering a code sent by the “Central Address-book” system to the user's e-mail address. It should be noted that another option could be for the voicemail to be translated into text using voice recognition software and sent in a text format to the recipient's e-mail or as SMS to his mobile phone or SMS enabled POTS phone, etc. Prior to the sending of the text, the “Central Address-book” system could provide the user with the translated text for approval either by vocalizing the text or by presenting it on the phone's caller ID screen. Please note that a voice to text or a text to voice operation may be accomplished on the server, on the device, or cooperatively there-between.

In the context of a voice to text or a text to voice operation. please note that translating voice to text using a voice line and sending it as a SMS message to a phone destination could be done by dialing (the server phone number or *8) from a phone with a visual interface that supports CWCID to the CAB (Central Address Book), finding the desired person's phone number using the CAB and then recording a voicemail that the CAB server will translate to text and send to the chosen phone number. Alternatively, instead of looking-up the person's phone number in a centrally located personal address-book the caller can simply enter the desired phone number by him self. The caller will dial to a server (by dialing either the server phone number or a shortcut such as *7), will enter the phone number to which the SMS should be sent; record the voice message and then the server would translate the voice message to text and send it as a SMS to the provided phone number. The server can optionally let the caller review the text message, which resulted from the translation of the voice message, prior to sending the message by either sending the text message to the phone's screen by, for example, taking advantage of the phone's support of CWCID or by vocalizing the text (if the recorded voice message is vocalized the caller could use any phone, not just phones that would enable him to visually navigate). The user could either approve the message for sending or amend it or record it again. That means that this could also be an application independent of the CAB method and/or system.

Clearly, there are other portions of the instant method that can accommodate this variation; albeit for reader convenience we propose an example wherein the “server arranging” in step (D) includes sub-step: (E1) the server accepting a communications command from the device, and the communications command is to establish a data transmission to an electronic address associated with a record of the Address-book; and (F1) the server establishing the data transmission. Nevertheless, one or both of these E1 and/or F1 may be an extension of the basic instant method without requiring any logic architecture relating them to the “server arranging” sub-step.

Now, according to one constructive mode of this fourteenth embodiment, the server establishing the data transmission includes the server sending a device specified message selected from the list: voicemail, email, Facsimile, SMS, audio content, visual content, alphanumeric content, and any combination of the aforesaid. Essentially, this mode allows for the facilitation of telecommunications other than just placing an ordinary voice to voice telephone call.

According to another constructive mode of this fourteenth embodiment, the server establishing the data transmission includes using a device specified electronic address type selected from the list: email address, telephone number, and voice mailbox number. Essentially, this mode allows for the use of any electronic address stored in the address book to be used to facilitate a telecommunications transmission or interaction.

According to a further constructive mode of this fourteenth embodiment, establishing the data transmission includes accepting voice content from the device and converting the voice content into substantially equivalent alphanumeric content. This is a facile service aspect of these embodiments whereby speech to text transformation software is applied in the chain of processing events so that a user may input a voice message while the actual final transmission is a text message. Likewise, the inverse software may be applied whereby a text message is transformed into a synthesized voice rendition, etc.

According to yet another constructive mode of this fourteenth embodiment, the user can elect whether to send a message to one recipient or multiple recipients. In one implementation, once the user issues a communication command to e-mail a specific recipient, the CAB may ask the user (either vocally or by sending text to the device screen) ‘press 1 if you are interested in sending the message to another recipient or 2 otherwise’. If the user chooses to send the message to more recipients the CAB will let the user further navigate the address book and designate additional recipients prior to being prompted to record a voice message that will be sent to all the recipients.

And finally, according to a different constructive mode of this fourteenth embodiment, establishing the data transmission may include sending a return reply address (such as a phone number of a specific device or an e-mail address).

Summarizing some aspects of the fourteenth embodiment, the “Central Address-book” system (method) is facile for the sending of voicemail to an e-mail or to a phone number or phone number voice mail-box. Using a high quality voice recognition system, the voice mail could also be translated to text and sent via e-mail or SMS to a destination. The voice mail will be sent either from the “Central Address-book” on behalf of ‘Mr. Subscriber’ or the Central Address-book can send e-mails using the subscriber's e-mail address so a person receiving the voice mail in an e-mail could reply directly to the subscriber. It should be noted that the “Central Address-book” may require the subscriber to confirm the ownership of the e-mail address he would like the Central Address-book system to be using when sending an e-mail on his behalf such as by providing the system with a code sent by the system to the e-mail address claimed by the user to be his.

For example, in case the voice mail was sent to the recipient using the user's e-mail address, regardless of how the recipient answers the e-mail—whether as text or by attaching a reply voice mail to the e-mail (the voice mail could be attached as an audio file to the e-mail), the reply would be sent to the user's e-mail address that was used to send the user's voice mail.

In case the voice mail was sent to the recipient using the Central Address-book system e-mail address (for example 2121234567@CAB.com where the 212-123-4567 is the user's phone number or John_Smith@CAB.com where John Smith is the user's name), the recipient will be able to see from the e-mail address which telephone number or which user is responsible for the voice mail attached to the e-mail; and the Central Address-book would know to whom it should route the reply, in case the user replies to the e-mail. The reply, if sent to an address of the CAB, would be received by the Central Address-book that based on recognizing whether the reply e-mail is text based or has a voice attachment, would route the message based on routing instructions given by the user. For example, a voicemail attached to the e-mail could be delivered by the Central Address-book—calling the user on his phone (mobile or landline or any number given by the user to receive voicemails replies) or by placing the voice mail in his voice mail system or by translating to text and sending to an e-mail address, etc.

Furthermore, in specific, according to a fifteenth instant embodiment, a routing construction of the instant invention relates to an embodiment of a method for routing a message (e.g. ordinary or transformed content such as e-mail, voice call, SMS, etc) using an internet accessible centrally located personal Address-book (CAB), the method including the steps:

### (A) a server, via Internet, receiving access to a user's Address-book, wherein the Address-book has more than one record;

### (B) the server accepting an incoming call or e-mail or SMS or fax or message to a subscriber (CAB user);

(C) using the caller/sender contact details from the incoming “item” (call, email, SMS, etc.) and/or from data in the CAB, the server Checking the subscriber address book for routing instructions (e.g. and the routing instructions may be specifically for a person, a category or the entire address book, etc.);

### (D) the server providing the routing instructions—or performing all or part of the routing.

Checking may include checking the current location of the subscriber, time of day and subscriber status, all conditions impacting the routing rules pre-defined by the subscriber. The subscriber location may be derived from the subscriber's mobile phone location. The subscriber status may be derived from the subscriber's calendar (in a meeting, Doctor's appointment etc).

Among the objects of this fifteenth embodiment, we note that geo-location based group calling (designating simultaneous signaling or ringing of proximate telecommunications devices—e.g. mobile telephone and land-line telephone) may be used in conjunction with the “Central Address-book” For example, incoming calls to a mobile phone will simultaneously ring on a pre-registered landline that the mobile phone is next to (e.g. calculated as being substantially proximate to). The user may specify that only calls from people under a user or system designated category or people in the “Central Address-book” will also be routed to the landline next to the mobile phone. Alternatively, only people under a different user or system designated category of the “Central Address-book” will not be routed to the landline (for example the doctor or the lover or a stock broker and an astrologer will only call the mobile). The “Central Address-book” may also have pre-set routing rules tied to particular or pre-registered locations. For example, people in the “Central Address-book” under personal category will be routed to landline next to me only when I am home, at work only to my mobile. Similarly, at work, only people under the business category of the “Central Address-book” will be routed to the work landline, other people such as friends, won't be routed. It is important to note that the routing instructions attached to specific contacts or categories of the Central Address-book and/or to the entire address-book could be provided to the Central Address-book system using a phone with a visual interface or by simply using a web based interface giving the user access to his centrally located personal address book.

Thus, according to one constructive mode of this fifteenth embodiment, accepting routing rules (using a phone's visual interface or web based interface for example) includes subjecting the establishment of a group call to routing rules designated by the user. Once a mobile phone has been determined to be next to a pre-registered landline (that the user is interested in having the option of answering incoming calls to the mobile phone on), a group calling function is established in the central office; a group call that is subject to routing rules which were established by the user using his Central Address-book. For example, an incoming call to the user's mobile phone from a work colleague defined in the Central Address-book under the ‘Business’ category will not be routed by the central office to both the mobile phone and the landline despite the group calling since the user asked that only calls to his mobile phone from people defined in the Central Address-book under the ‘Personal’ category will be routed also to his home landline. Preferably, establishing a routing protocol includes designating the at least one electronic address (electronic address could be a phone number) as a call forwarding or group calling extension when the geo-location specification for the device is substantially proximate to a physical location associated with the respective at least one electronic address.

For example, a CAB server located at a cellular carrier central office could have the following routing rule defined by a subscriber: the home phone number of the subscriber will be used with the subscriber's mobile phone number for Group Calling (and the group calling will be established only when the subscriber will be determined to be at home) for incoming calls originating from people in the subscriber's ‘Personal’ category of the address book. Other incoming calls to the subscriber's mobile phone from people not in the subscriber's ‘Personal’ category of the address book will be routed only to the mobile phone despite the fact the subscriber is at home.

Nevertheless, according to another constructive mode of this fifteenth embodiment, routing instructions provided by the user include designating at least one record of the address book for a routing status selected from the list: priority routing, conditional routing, and predetermined messaging routing. Priority routing may be used to best appreciate when a circumstance demands making a best effort to allow or facilitate telecommunications—such as reaching an emergency service or overriding existing telecommunications in preference to an important special telecommunications (e.g. a call from the boss will put any other telecommunications on hold, etc.). Conditional routing may be as a means for establishing a rules set to include specific address book entries, time of day, location, mode of telecommunications, level of activity, or the likes.

Now, we will relate to a few non-limiting examples of routing incoming calls to a landline based on the mobile phone location using the CAB (Using CAB to route incoming calls to different phone numbers, voicemail, e-mail with a voice attachment, e-mail with voice translated to text etc).

For example, the caller ID of an incoming call to a user's landline, whose personal Address book is stored at the POTS central office CAB server, could be used to locate a specific CAB record or a rule set “decision” designating that the call from a specific person should be routed to the mobile phone when the user is not next to the POTS landline. In one possible implementation, the CAB server at the POTS central office will know that the user is not next to the POTS landline since a software located on the mobile phone will recognize that the mobile phone is no longer next to the POTS landline and send a SMS to the CAB server located at the POTS central office informing it that the mobile phone is no longer next to the landline. In another example, according to the caller ID a routing rule will be found that a call from people in the category the caller belongs to, should be routed to a voice mail system where a voice message will be recorded, translated to text and sent as a SMS to the user's mobile phone when he is not next to the landline.

Using the CAB web interface, a user can define how incoming calls from contacts belonging to certain categories will be handled as well as how incoming calls from specific contacts will be handled. For example, all calls but calls from the user's boss to the user's mobile will be routed to voicemail when the user is in a meeting. Voicemails left by people belonging to the ‘business’ category of the user's CAB will also be forwarded to the user's e-mail.

The geo-location based group calling will be used in conjunction with the CAB for both routing incoming calls to the mobile phone as well as routing incoming calls to a landline. For example, only incoming calls to the mobile phone from people under the ‘personal’ category will be routed to the home phone in addition to the mobile phone when the user is recognized to be at home. Incoming calls from people in other categories, including the ‘business’ category, will be routed only to the mobile phone.

When at work, incoming calls to the mobile phone from people under the ‘business’ category will be routed to the work phone in addition to the mobile phone. People under the ‘personal’ category will be routed to the mobile only. (e.g. The family doctor calls will always be routed only to the mobile phone.)

Once the mobile phone is determined to be no longer next to a landline, a “CAB service provider” server located at the landline company central office will be informed (via a SMS sent from the geo-location based group calling application located on the mobile phone for example) and incoming calls to a home landline will be routed according to the caller number to cell phones of different members of the household. For example, callers that their phone number is included in the man's CAB will be forwarded to the man's cell phone when he is not at home. In another example, callers that their phone number is included in both the man and women (residing in the same household) Central Address Books (we assume that from the same home landline, each family member could access his own centrally located personal address book) will be forwarded to man's and woman's mobile phones simultaneously and who ever picks up the phone first will answer. Using their CAB users can define routing rules for routing incoming calls to their mobile phone depending on their location (home, office, etc), time of day, CAB category, status (as reflected in their diary for example—in a meeting, busy, free etc. The diary could be a central diary connected to the Central Address Book), specific contact or any combination thereof.

Using the CAB, users can define routing rules for routing incoming calls to their landline depending on their mobile phone location, time of day, status (as reflected in their diary for example—in a meeting, busy, free etc. The diary could be a central diary connected to the Central Address Book), CAB category, specific contact or any combination thereof.

Now, in addition to the embodiments and variations heretofore presented, there are other noteworthy aspects for extending functionality of the central address book method.

One aspect of extended functionality relates to Synchronizing CABs used by landline and cellular operators. In order to provide a subscriber with access to his CAB, both on his landline as well as on his mobile phone, Central Address-book servers could be placed both at the landline provider Central Office as well as the cellular carrier office. The Central Address-book servers operating at the landline and cellular carriers premises, will keep their CAB databases synchronized using a secure connection over the web for example.

Another aspect of extended functionality relates to Using CAB to improve incoming calls Caller ID. An incoming call phone number will be matched with the person's centrally located address book (CAB) records. In case of match, the name of the calling person will be taken from the person's CAB instead of a public database.

Now, a further aspect of extended functionality relates to Using CAB to call using client software. A telecom provider giving its users the option to call from their computers using a VOIP application or a WiFi dedicated phone can use an open API provided by CAB to enable the user to browse the CAB from his VOIP client software.

Furthermore, yet another aspect of extended functionality relates to Statistics building based on CAB usage specifically as well as calls made by the user in general (with or without the CAB). Statistics are built of the numbers most commonly dialed by the user.

In addition, there is an aspect of extended functionality that relates to Synchronizing a local mobile handset address book with CAB based on CAB statistics.

The most commonly dialed numbers by the user are sent (wirelessly via SMS for example) to the user's mobile phone address book to provide the user with a local address book. In case of a mobile subscriber roaming where he can not visually navigate the CAB, he can use the mobile's phone address book that was populated by the CAB or alternatively gain access to the entire CAB by dialing to the CAB and navigating through the CAB using voice commands.

Finally, there is a further aspect of extended functionality that relates to using the CAB to build and provide access to a central repository of e-mails, SMS, call records and voice mails. Using a web interface, a user can view the e-mail correspondence, SMS correspondence and records of calls (to and from) for each contact in his CAB. Records of calls will include calls made and received on both a user's landline as well as a user's mobile phone (with or without the CAB).

Now, it can be appreciated that there are many variations of a “Central Address Book (CAB) oriented system” in accordance with instant method. These variations may be embodied partially, individually, and/or in combination. In conclusion, we will now itemize some of these variations:
I. Building/Editing CAB via exporting of existing address book or usage of web interface: User can export its Microsoft Outlook Contacts or web based address book (such as provided by Yahoo) by exporting the contacts in those applications into a CSV file. The user will then upload the CSV file to the CAB web site. The user can create an address book using the CAB web site interface or edit an exported address book using the interface.
II. Synchronizing other Address books with CAB: The user can download client software that will monitor its contacts and whenever it will recognize the addition of new contacts, the software will give the user the opportunity to update the CAB with the new contacts.
III. Synchronizing CABs used by landline and cellular operators: In order to provide a subscriber with access to his CAB both on his landline as well as his mobile phone, CAB servers could be placed both at the landline provider Central Office as well as the cellular carrier office. The CAB servers, operating at the landline and cellular carriers premises, could keep their CAB databases synchronized by using a secure connection over the web—for example: The CAB servers located at the central offices of the landline company and the cellular company could be owned by the landline company and the cellular company respectively or by a third party offering the service directly to subscribers. Regardless of who owns and operates the CAB servers it makes sense to synchronize them for the benefit of the subscriber that uses both the landline and the cellular.
IV. Accessing & Navigating CAB: The user will access the CAB from a landline by using any phone supporting CWCID (Call Waiting Caller ID) to dial *8. From a mobile phone the user will dial ‘2’ (the digit ‘2’ will be programmed to dial the “CAB service provider” server number the same way the digit ‘1’ is programmed to dial the voicemail server number). Once connected to the “CAB service provider” server, the user's phone screen will recognize the user and the following message will appear on the phone's screen ‘John's Address Book’ (in case the user's name is obviously John). The phone number of the phone used by the user to call the “CAB service provider” server will be used by the server to identify the user and provide him with the correct address book. The user has the option of protecting his address book with a PIN code. Once connected, the user will use his phone's keypad to navigate his centrally located personal address book. The user's commands (uplink) will be sent via DTMF and in response the “CAB service provider” server will deliver the CAB records to the phone's caller ID screen (downlink). The user will move to the next record by pressing the # key, to the previous record by pressing the * key, to the next level by pressing the digit ‘1’ and to the previous level by pressing the digit ‘0’. The CAB is arranged as a tree where the contact names are the branches and each of the contact's phone numbers or e-mail are the leaves of the contact. For example, a user looking for ‘John Bell’ could sort through the names in his CAB using the # key, once the name ‘John Bell’ appears on the screen, the user will press the digit ‘1’ and then will be able to sort through John Bell's contact numbers and e-mail. When the phone number the user is interested in reaching will be on the screen (John Bell's Work number for example) the user will press the digit ‘1’ again and the “CAB service provider” server will connect the user with the desired phone number. If the user realized that he chose the wrong name, he can always press the digit ‘0’ and go back up one level in the tree to the names level. The user can jump directly to a certain name by entering the first or last name of the contact's name using the keypad. Once finished entering the name the user will press the digit ‘1’. The CAB in response will let the user scroll through all the names matching the letter combinations created by the pressed digits. The user can go back to the CAB names level by pressing ‘0’ or the desired name by pressing ‘1’. A user, not comfortable with a tree structure, can choose to have his CAB organized as one level where contacts' different phone numbers and e-mails are organized sequentially.
V. Using CAB to call: Once a user has his desired contact phone number on the phone's screen, the user will press the digit ‘1’ and the “CAB service provider” server will connect the user to its desired destination. The call record including date, time and duration will be reported to the user by its telecom provider as all other calls made by the subscriber since the “CAB service provider” server once receiving the instruction to connect the user to the desired number will transfer the number to the telecom provider that will connect the user to his destination.
VI. Using CAB to send voicemail to e-mail or phone: A user has the option of sending a voicemail to a contact e-mail. While e-mail is a convenient way to communicate, it is much faster to communicate a message using voice than using a keyboard to type it. CAB provides users with the combined strength of e-mail and voice communications by enabling a user to send a voicemail to a contact's e-mail address. Once a user has a contact's e-mail address on the phone screen the user can press the digit ‘1’ and be prompted to record a voice message that will be sent to the desired e-mail address. The user can record and review the voice mail prior to sending it. The e-mail with the attached voice message could be sent from the CAB e-mail address ‘on behalf of Mr. User’ or could be sent by the CAB server using the user's e-mail address to enable the e-mail recipient to reply directly to the user. To prevent fraud, the CAB will ask a user to confirm ownership of his e-mail address by entering a code sent by the CAB to the user's e-mail address. It should be noted that another option could be for the voicemail to be translated into text using voice recognition software and sent in a text format to the recipient's e-mail. Prior to the sending of the text, the CAB could provide the user with the translated text for approval either by vocalizing the text or by presenting it on the phone's caller ID screen.
VII. Using voice commands with CAB: Users can access CAB from any phone, using voice commands to call or e-mail voicemail to desired contacts. The voice commands will be deciphered by the system using voice recognition software.
VIII. Using CAB to improve incoming calls Caller ID: An incoming call phone number will be matched with the person's centrally located address book (CAB) records. In case of match, the name of the calling person will be taken from the person's CAB instead of a public database.
IX. Using CAB to call using client software: A telecom provider giving its users the option to call from their computers using a VOIP application can use an open API provided by CAB to enable the user to browse the CAB from his VOIP client software.
X. Using CAB to route incoming calls to different phone numbers, voicemail, e-mail in a voice format: Using the CAB web interface, a user can define how incoming calls from contacts belonging to certain categories will be handled as well as how incoming calls from specific contacts will be handled.

For example, all calls but calls from the user's boss to the user's mobile will be routed to voicemail when the user is in a meeting. Voicemails left by people belonging to the ‘business’ category of the user's CAB will also be forwarded to the user's e-mail.

The geo-location based group calling will be used in conjunction with the CAB for both routing incoming calls to the mobile phone as well as routing incoming calls to a landline. For example, only incoming calls to the mobile phone from people under the ‘personal’ category will be routed to the home phone in addition to the mobile phone when the user is recognized to be at home. Incoming calls from people in other categories, including the ‘business’ category, will be routed only to the mobile phone.

When at work, incoming calls to the mobile phone from people under the ‘business’ category will be routed to the work phone in addition to the mobile phone. People under the ‘personal’ category will be routed to the mobile only.

The family doctor calls will always be routed only to the mobile phone.

Once the mobile phone is determined to be no longer next to a landline, a CAB server located at the landline company central office will be informed (via a SMS sent from the geo-location based group calling application located on the mobile phone for example) and incoming calls to a home landline will be routed according to the caller number to cell phones of different members of the household. For example, callers that their phone number is included in the man's CAB will be forwarded to the man's cell phone when he is not at home. In another example, callers that their phone number is included in both the man and women (residing in the same household) Central Address Books (we assume that from the same home landline, each family member could access his own centrally located personal address book) will be forwarded to man's and woman's mobile phones simultaneously and who ever picks up the phone first will answer. Using their CAB users can define routing rules for routing incoming calls to their mobile phone depending on their location (home, office, etc), time of day, CAB category, specific contact, status (as reflected in a central diary) or any combination thereof. Using the CAB users can define routing rules for routing incoming calls to their landline depending on their mobile phone location, time of day, CAB category, specific contact, status (as reflected in a central diary) or any combination thereof.
XI. Using CAB to route incoming e-mails to different e-mail addresses, different phone # via SMS, different phone # via voiced text: Using the CAB web interface, a user can ask to be alerted with a SMS when e-mails from certain contacts in the CAB arrive into his inbox. The user can also ask to receive specific e-mails in a voice format into his voicemail. Such a service could provide the user with an immediate access to an important e-mail if he has no e-mail access for an extended time.
XII. Using the CAB to build and provide access to a central repository of e-mails, SMS, call records and voice mails: Using a web interface, a user can view the e-mail correspondence, SMS correspondence and records of calls (to and from) for each contact in his CAB. Records of calls will include calls made and received on both a user's landline as well as a user's mobile phone (with or without the CAB).
XIII. Sending SMS using the CAB phone interface: Instead of entering a SMS message using the phone keypad, the SMS message will be given using voice, the system will translate the voice message to text using a voice recognition software and will enable the user to approve the correctness of the translation by either presenting the translated text on the phone's caller ID screen or by vocalizing the translated text. Once the user approves the translation, the text message is sent. In case the user is not happy with the translation, he can repeat the message or part of it.
XIV. Receiving SMS using the CAB phone interface: An SMS could be sent to any landline phone supporting CWCID. The phone will ring and the caller ID screen will state ‘SMS from phone #’ of the sender. Once the user answers the phone, the caller ID screen will present the SMS, which the user could scroll through by pressing the # key to get the next part of the message or the * key to the get the previous part of the SMS. The user could further reply to the message with a SMS as described above (using voice that will be translated to text) or with a SMS chosen out of a few available templates. By pressing the digit ‘1’ when reviewing the SMS message the user is given the option to reply. When answering with a template, on the phone screen appear possible answers the user can scroll through (using the # and * keys) and choose from such as ‘ok’, ‘will do it’, ‘can not do it’, ‘have a problem, call me’, ‘can not do it. Call me’ etc. Once the user finds the reply of his choice he presses the digit ‘1’ again to have the SMS sent.
XV. Using CAB to auto-complete e-mail addresses in web based e-mail via a java script: Users can benefit from an auto-complete of e-mail addresses they start to write in a web based e-mail application via a java script.
XVI. Statistics building based on CAB usage: Based on calls made by the user, statistics are built of the numbers most commonly dialed by the user.
XVII. Synchronizing a local mobile handset address book with CAB based on CAB statistics: The most commonly dialed numbers by the user are wirelessly sent to the user's mobile phone address book to provide the user with a local address book. In case of a mobile subscriber roaming, he can gain access to the entire CAB using voice commands or to the numbers most commonly dialed by him from the handset local address book.

Returning now to the receiving of routing instructions from the user and the execution of the instruction when receiving incoming communication intended for the user, the server may receive routing instructions from the user using a web interface for example. Upon receiving an incoming communication intended for the user, based on the user's location as it appears in the CAB records (the CAB server is updated with the user's location every time that it changes. For example, a geo-location based group calling software located on a mobile phone will inform the CAB server using SMS when the user gets home, when he leaves his home, when he gets to the office, when he leaves the office etc), based on time of day, the caller/sender ID and the routing instructions for calls/messages originating from this caller/sender or people that belong to the category the caller/sender belong to, based on the communication format (voice, text, video etc), based on the user's status (as reflected in a central diary) etc the server will determine to where should the incoming communication be routed and in what format. The server will either route the communication it self or provide the routing instructions to another server that will route the communication. The routing instructions may further include the establishing of a data transmission or a voice connection to at least one electronic address associated with a record of the address-book. The instructions may include accepting a substantially real-time geo-location specification for the device. Establishing a routing protocol may include designating the at least one electronic address as a call forwarding or group calling extension when the geo-location specification for the device is substantially proximate to a physical location associated with the respective at least one electronic address. The routing instructions may include designating at least one record of the address book for a routing status selected from the list: priority routing, conditional routing, and predetermined messaging routing. The received routing instructions may include establishing a voice connection to an electronic address associated with a record of the address book, and executing the routing instructions may include the server establishing the routing by establishing a voice connection. Similarly, receiving routing instructions may include sending a voice mail to an e-mail address associated with a record of the address book, and executing the routing instructions may include the server recording a voice mail and e-mailing it to the desired e-mail address.

While the invention has been described with respect to specific examples including many presently preferred modes of carrying out the invention, those skilled in the art will appreciate that there are numerous variations and permutations of the above described methods, systems, and techniques that fall within the spirit and scope of the invention as set forth in the appended claims.

1. A method for interacting via an internet accessible address-book using a visual interface phone device, the method including the steps:
(A) a server, via Internet, receiving access to a user's address-book, wherein the address-book has more than one record;
(B) the server accepting a dial-up connection from the user, wherein the dial-up is from a visual-interface-enabled voice-network-operative telephone device;
(C) the server receiving navigation commands from the device, and the commands are for navigating within the address-book; and
(D) the server sending at least one portion of a record in the address-book to the device, and the server arranging for the at least one portion to be sent in a format readable by the visual-interface-enabled voice-network-operative telephone device.

2. The method of claim 1 further including steps:
(E) the server accepting a communications command from the device, and
(F) the server executing the communication command.

3. The method of claim 1 wherein the step of receiving access to a user's address-book includes the server accommodating a user provided copy of the address-book, and the accommodating is accomplished between the user and the server via the internet.

4. The method of claim 1 wherein the step of receiving access to a user's address-book includes granting to the server access to an internet based address-book.

5. The method according to claim 4 wherein the step of granting the server access includes using a predetermined internet communications protocol schedule for updating the address-book from an internet-accessible substantially most up-to-date version of the address-book.

6. The method of claim 1 wherein the step of accepting a dial-up connection includes the server accessing an internet-accessible substantially most up-to-date version of the address-book and incorporating heretofore unincorporated updates that have been made thereto.

7. The method of claim 1 wherein the step of receiving navigation commands further includes the server accessing an internet-accessible substantially most up-to-date version of the address-book and presenting content therefrom to the user.

8. The method of claim 1 wherein the step of accepting a dial-up connection includes accepting transmissions of communications occurring over a protocol selected from the list: an SS7 protocol, a Cellular telephone protocol, a VOIP protocol, and a POTS protocol.

9. The method of claim 1 wherein the step of receiving navigation commands from the device includes interpreting a navigation command that corresponds to a user pressing at least one key on a keypad of the device.

10. The method according to claim 9 wherein the step of interpreting a navigation command includes accepting transmissions of communications encoded as DTMF.

11. The method of claim 1 wherein the step of receiving navigation commands from the device includes interpreting voice commands of the user.

12. The method of claim 1 wherein the step of sending at least one portion of a record in the address-book to the device includes sending of the said at least one portion in a format readable to the phone device as a ‘call waiting caller ID’.

13. The method of claim 2 wherein the step of accepting a communications command includes interpreting a communication command that corresponds to a user pressing at least one key on a keypad of the device.

14. The method according to claim 13 wherein the step of interpreting a communication command includes accepting transmissions of communications encoded as DTMF.

15. The method of claim 2 wherein the step of accepting a communications command includes interpreting a voice command of the user.

16. The method of claim 2 wherein executing the communications command includes establishing a voice connection with an electronic address delivered to the device by the server and the server dialing up the electronic address; thereby connecting the user to an entity corresponding to the electronic address in a chosen address-book record.

17. The method of claim 2 wherein executing the communication command includes recording of a voice message from the user and sending the voice message to an e-mail address.

18. The method of claim 2 wherein executing the communication command includes recording of a voice message from the user and sending the voice message to an e-mail address as an audio file attachment.

19. The method of claim 2 wherein executing the communication command includes recording of a voice message from the user transforming the voice message into text and sending the text to an e-mail address.

20. The method of claim 19 wherein sending the text includes sending the text back to the device and accepting a text approval or a text amendment from the device user; such that the text sent to the email address is approved.

21. The method of claim 20 wherein sending the text back to the device includes arranging for the text to be sent in a format viewable on a screen of the device.

22. The method of claim 19 wherein sending the text to an email address includes transforming the text into a vocalized version, sending the version back to the device and accepting a version approval or a version amendment from the device user; such that the email includes the approved version.
